(19) United States
(12) Patent Application Publication
(10) Pub. No.: US 2023/0131669 A1
(43) Pub. Date: Apr. 27, 2023

(54) BACKGROUND DIMMING WITH GAZE DETECTION

(71) Applicant: HEWLETT-PACKARD DEVELOPMENT COMPANY, L.P., Spring, TX (US)

(72) Inventors: Pei Hsuan Li, Spring, TX (US); Peter Zhang, Spring, TX (US); Rose Hedderman, Spring, TX (US)

(73) Assignee: HEWLETT-PACKARD DEVELOPMENT COMPANY, L.P., Spring, TX (US)

(21) Appl. No.: 17/451,864

(22) Filed: Oct. 22, 2021

(51) Int. Cl. G09G 3/34; G06F 3/01; G09G 5/10

(52) U.S. Cl. CPC G09G 3/3406; G06F 3/013; G09G 5/10; G09G 2320/0233; G09G 2320/0626; G09G 2320/0693

(57) ABSTRACT

An example computing device according to the systems and methods described herein may include a camera to capture images of a user during operation of a computing device. The computing device may execute a plurality of applications, some of which may include application windows displayed on a display panel of the computing device. A gaze detection subsystem or module may detect a gaze direction of the user in each of the captured images. For each captured image, the gaze detection subsystem or module may compute or otherwise identify the user's focus on one or more application windows displayed on a display panel of the computing device. A brightness control module may modify the relative brightness of each application window displayed on the display panel based on a function of the frequency of user focus, duration of user focus, and recency of user focus on each respective application window.

### BACKGROUND

Brightness settings of an electronic display device allow users to adjust the brightness of a display panel. Some electronic display devices include a single backlight, such that the brightness of the display panel is uniformly modified by brightness adjustments. Some electronic display devices allow for individual pixel dimming or dimming zones or regions, commonly referred to as local dimming. Local dimming allows for dynamic dimming of the display panel backlight based on the displayed content. For example, the backlighting associated with certain zones of pixels, or even individual pixels, may be dimmed when displaying darker scenes and brightened when displaying lighter scenes.

### BRIEF DESCRIPTION OF THE DRAWINGS

Non-limiting and non-exhaustive examples of the disclosure are described, including various examples of the disclosure, with reference to the figures described below.

FIG. 1A illustrates an example diagram of a user operating a computing device while focusing on a first application executing thereon.

FIG. 1B illustrates the example diagram of the user operating the computing device while focusing on a second application executing thereon.

FIG. 2 illustrates a block diagram of an example of a computing device to detect gaze and adjust the relative brightness of application windows based on user focus metrics.

FIG. 3 illustrates an example of a computing system with various modules to detect user focus and adjust the relative brightness of application windows based on user focus metrics.

FIG. 4 illustrates a flow chart of an example method to adjust the brightness of an application window relative to another application window based on measured user focus metrics.

FIG. 5A illustrates an example of discrete user focuses on a first application window.

FIG. 5B illustrates an example table with the user focus metrics associated with the discrete user focuses.

FIG. 5C illustrates an example of a background application window dimmed in response to user focus metrics.

FIG. 6A illustrates another example of discrete user focuses on a first application window and a second application window.

FIG. 6B illustrates an example table with the user focus metrics associated with the discrete user focuses.

FIG. 6C illustrates an example display panel with adjustments to the relative brightness of the first application window, the second application window, and the background based on user focus metrics.

FIG. 7A illustrates another example of discrete user focuses on a first application window and a second application window.

FIG. 7B illustrates an example table with the user focus metrics associated with the discrete user focuses.

FIG. 7C illustrates an example display panel with the background application window dimmed relative to the active first and second application windows, based on the user focus metrics.

FIG. 8A illustrates an example of discrete user focuses on a background application window and a first application window.

FIG. 8B illustrates an example table with the user focus metrics associated with the discrete user focuses.

FIG. 8C illustrates an example display panel with the brightness of the background application window increased relative to the first application window, based on the user focus metrics.

### DETAILED DESCRIPTION

According to various examples described herein, a computing device or a display panel controller of the computing device, selectively dims inactive application windows and/or increases the brightness of active application windows. In many instances, a computing device executes multiple applications at the same time. The computing device may display the application windows of several applications on a display panel of the computing device at the same time. However, the user of the computing device may not be actively using all the applications at the same time. For example, a user may leave an email application window open on one portion of the display panel while actively using a word processing application window on another portion of the display panel.

In various examples, the system monitors the gaze direction of the user to determine the user's focus at any given time. At each of a plurality of instances, the system may identify the user focus as being directed to one of the application windows displayed on the display panel of the computing system. The user focus may switch between multiple application windows or may be maintained on a single application window. In some examples, the system identifies application windows as active or inactive and adjusts the relative brightness accordingly.

In various examples, the system adjusts the relative brightness of each application window based on a weighted function of the frequency of the user focus on each respective application, the duration of the user focus on each respective application, and/or the recency of focus on each respective application. In some instances, focus thresholds may be associated with each application. For example, the system may dim the application window of any application for which the frequency, duration, or recency of the user focus is below established threshold values. In some examples, the frequency of focus threshold, the duration of user focus threshold, and the recency of focus threshold of each application are the same. For example, global threshold values can be applied to all applications or to all applications for which application-specific threshold values have not been set by a user, determined via calibration, and/or otherwise established.

In some examples, the system monitors user focus during user-operation of one or more applications during a calibration time period. The system determines application-specific frequency of focus thresholds, duration of user focus thresholds, the recency of focus thresholds, or a combination thereof for each respective application.

In various examples, the system determines the frequency of focus threshold for a given application as the average number of user focus switches to the given application during a defined time unit. For example, a user operating a computing device may be using an email application, a word processing application, and a PDF viewer application. The user may be primarily utilizing the word processing application, but periodically switching user focus to the email application and the PDF viewer application. An example frequency of focus threshold for the email application might be once per 100 seconds (0.01 switches per second), while an example frequency of focus threshold for the PDF viewer application might be once per 1000 seconds (0.001 switches per second). The frequency of focus threshold for the word processing application might be once per 10,000 seconds (0.0001 switches per second).

The system utilizes the frequency of focus threshold to ensure that the application windows of applications that are used frequently (e.g., the email application in the example above) are not dimmed as quickly as the application windows of applications that are used less frequently (e.g., the word processing application). For example, even if the user had taken notes or otherwise utilized the word processing application for a long period of time in the morning, the application window for the word processing application might still be dimmed relatively quickly since the word processing application is considered to be used less frequently than other applications.

The frequency of focus threshold of a given application might vary between different users. For example, a user in a technical role may check their email in the morning, once at lunch, and then again before leaving for the day. The frequency of focus threshold for the email application for the technical user might be once per 25,000 seconds (0.00004 switches per second). In contrast, a user in a salesperson role might check their email every few minutes, and the frequency of focus threshold for the email application for the salesperson might be once per 250 seconds (0.004 switches per second). The system operates to dim the application window as an inverse function of the frequency of focus threshold. Accordingly, the system may operate to dim the application window of the email application for the technical user much more quickly than for the salesperson.

For instance, the system may compute a frequency of focus threshold of 400 seconds for the email application of the salesperson (using an example function in which frequency of focus threshold is computed as 100,000 multiplied by the number of switches per second—100,000×0.004=400). The system may compute the frequency of focus threshold of 4 seconds for the email application of the technical user (again, 100,000×0.00004=4). Using this example function for computing the frequency of focus threshold, the system may dim the application window of the email application of the salesperson if more than 400 seconds have elapsed since the salesperson last focused on the email application. Similarly, the system may dim the application window of the email application of the technical user when more than 4 seconds have elapsed since the technical user last focused on the email application.

In various examples, the system determines the duration of focus threshold for a given application as the average amount of time the user maintains user focus on the given application before switching user focus to a different application. Using the example above, the user may operate the word processing application and the PDF viewer application for extended periods of time, with periodic glances at the email application. Example duration of focus thresholds for the word processing application, the PDF viewer application, and the email application might be 480 seconds, 360 seconds, and 180 seconds, respectively.

As another example, a user may utilize a graphical design application for long periods of time with periodic usage of a conference calling application for quick meetings. The system may dim the application window of the conference calling application relatively quickly as compared to the application window of the graphical design application. The duration of focus threshold for the conference calling application window might be 180 seconds for the particular user. The system may dim the application window of the conference calling application if the last detected user focus occurred more than 180 seconds in the past.

In various examples, the system determines the recency of focus threshold for a given application as an average amount of time that elapses before the user switches the user focus back to the given application (e.g., from a second application back to the application for which the recently of focus threshold is being determined). Continuing with the example above, the user may glance at the email application on a very consistent basis, use the word processing application for extended periods of time, and use the PDF viewer application less frequently. Example recency of focus thresholds might be 20 seconds for the email application, 200 seconds for the word processing application, and 500 seconds from the PDF viewer application.

As an example, a user may utilize a slideshow creation application for long periods of time, but then not return to that application until much later. The recency of focus threshold for the slideshow creation software might be relatively long (e.g., 360 seconds). The system may periodically determine a recency of focus metric for the slideshow creation application. The system may dim the application window of the application window of the slideshow creation application when the recency of focus metric exceeds the recency of focus threshold for the slideshow creation application.

In some examples, the brightness of each application window may be set to a “normal” or “default” brightness, and then dimmed when determined to be inactive. Alternatively, the brightness of each application window may be set to a dim state, and then the brightness may be increased when determined to be active.

In various examples, the system determines the gaze direction of the user via analysis of images captured of the user during operation of the computing device. For example, a camera of the computing device may be used to capture images of the user during operation of the computing device. The system may utilize any of a wide variety of gaze direction detection techniques including, but not limited to, eye tracking, head tracking, focus detection, optical image analysis of corneal reflections, or a combination thereof. In some examples, the camera used to determine the gaze direction may be a full-function optical camera of the computing device useful for other purposes, such as video conferencing, facial recognition, photography, and/or the like.

In some examples, the camera used to determine the gaze direction of the user may be application-specific and used only for determining the gaze direction of the user. Examples of suitable cameras include, but are not limited to, charge-coupled device (CCD)-based cameras, complimentary-metal-oxide semiconductor (CMOS)-based cameras, full color (e.g., RGB) cameras, infrared cameras, near-infrared cameras, and the like. In some examples, the camera may be integrated as a part of the computing device or associated casing. In other examples, the camera may be externally connected to the computing device via a wireless or wired data connection.

In one example, the computing device includes a display panel and a camera to capture images of the user during the use thereof. A gaze detection subsystem may detect gaze directions of the user in the captured images and identify discrete user focuses on a first application window displayed via the display panel. The gaze detection subsystem may be embodied as electronic logic circuitry, a field-programmable gate array, a programmable logic controller, computer-readable instructions executable by a processor, or a combination thereof. The computing device may calculate or compute user focus metrics, such as the frequency of user focus, the duration of user focus, the recency of user focus, or combinations thereof. A brightness control subsystem may modify the relative brightness of the first application window based on computed user focus metrics. The brightness control subsystem may be embodied as electronic logic circuitry, a field-programmable gate array, a programmable logic controller, computer-readable instructions executable by a processor, or a combination thereof.

In some examples, the computing device also includes an application assignment subsystem that determines application-specific focus thresholds, such as a frequency of focus threshold, a duration of focus threshold, a recency of focus threshold, or a combination thereof. The system may compare instantaneous or average user focus metrics of an application with one or more of the focus thresholds to decrease or increase the brightness of the first application window, decrease or increase a brightness of a second application window of a second application executing on the computing device, increase or decrease a brightness a background displayed on the display panel, or a combination thereof.

In some examples, the systems and methods described herein may be implemented by a processor of a computing device executing instructions stored on a non-transitory computer-readable medium. The term non-transitory does not encompass transitory propagating signals. Execution of the instructions stored on a non-transitory computer-readable medium may cause a computing device to perform various operations or functions, as described herein. The executable instructions may be physically or conceptually divided into discrete modules or blocks of instructions, in some examples.

For example, a non-transitory computer-readable medium may include instructions stored thereon that, when executed by a processor of a computing device, cause the computing device to detect gaze directions of a user captured images, compute a discrete user focus for each captured image on a first application window associated with a first application, and then adjust the relative brightness of the first application based on user focus metrics. Again, the user focus metric may include a frequency of user focus on the first application window, a duration of user focus on the application window, a recency of focus on the first application window, or a combination thereof. Adjustment of the relative brightness of the application window may be based on a comparison of one or more of the user focus metrics with user focus thresholds, such as a frequency of focus threshold, a duration of focus threshold, a recency of focus threshold, or a combination thereof.

As used herein, a basic input/output system (BIOS) refers to hardware or hardware and instructions to initialize, control, or operate a computing device prior to execution of an operating system (OS) of the computing device. Instructions included within a BIOS may be software, firmware, microcode, or other programming that defines or controls functionality or operation of a BIOS. In one example, a BIOS may be implemented using instructions, such as platform firmware of a computing device, executable by a processor. A BIOS may operate or execute prior to the execution of the OS of a computing device. A BIOS may initialize, control, or operate components such as hardware components of a computing device and may load or boot the OS of computing device.

In some examples, a BIOS may provide or establish an interface between hardware devices or platform firmware of the computing device and an OS of the computing device, via which the OS of the computing device may control or operate hardware devices or platform firmware of the computing device. In some examples, a BIOS may implement the Unified Extensible Firmware Interface (UEFI) specification or another specification or standard for initializing, controlling, or operating a computing device.

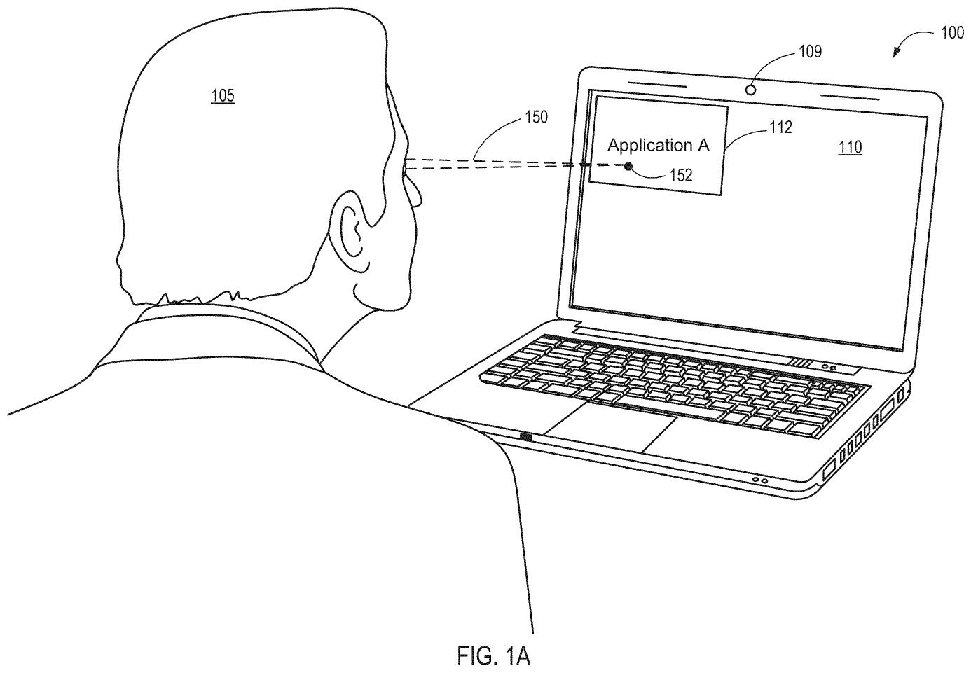

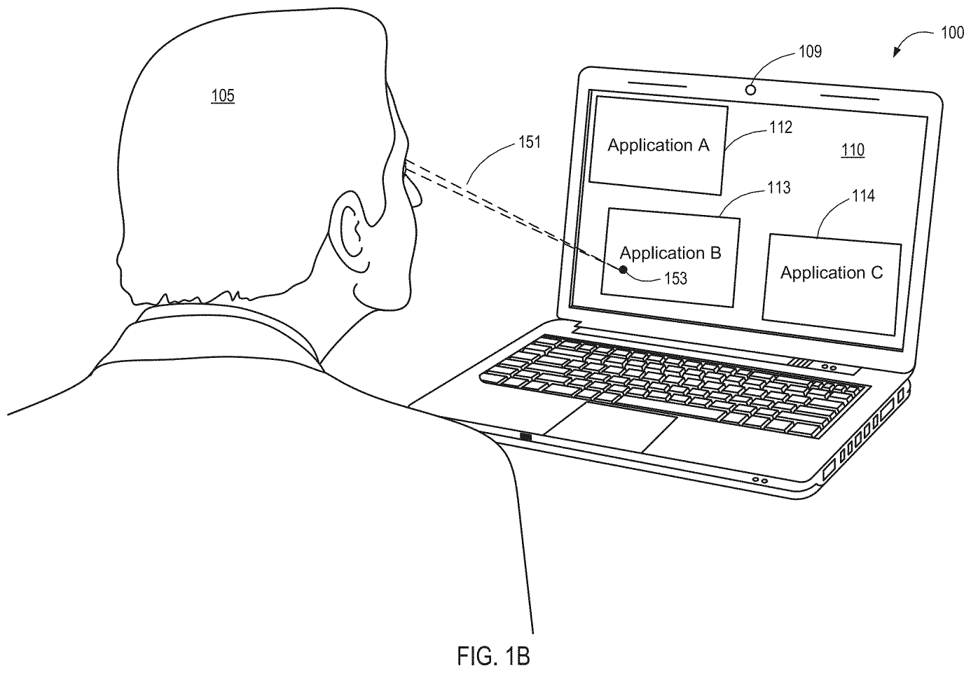

FIG. 1A illustrates an example diagram of a user 105 operating a computing device 100 while focusing on a first application window 112 displayed on a display panel 110 of the computing device 100. The gaze direction 150 of the user 105 can be determined by the computing device 100 using images of the user 105 captured by a camera 109. The computing device 100 may compute the user focus 152 associated with the detected gaze direction 150 as being associated with the first application window 112

FIG. 1B illustrates the example diagram of the user 105 operating the computing device 100 while focusing on a second application window 113 displayed on the display panel 110 of the computing device 100. Through analysis of a subsequent image or sequence of images, captured by the camera 109, the computing device may detect the gaze direction 151 associated with a user focus 153 on the display panel 110 that corresponds to the second application window 113. In the illustrated example, the user 105 is not focused or looking at the first application window 112 or the third application window 114 on the display panel 110.

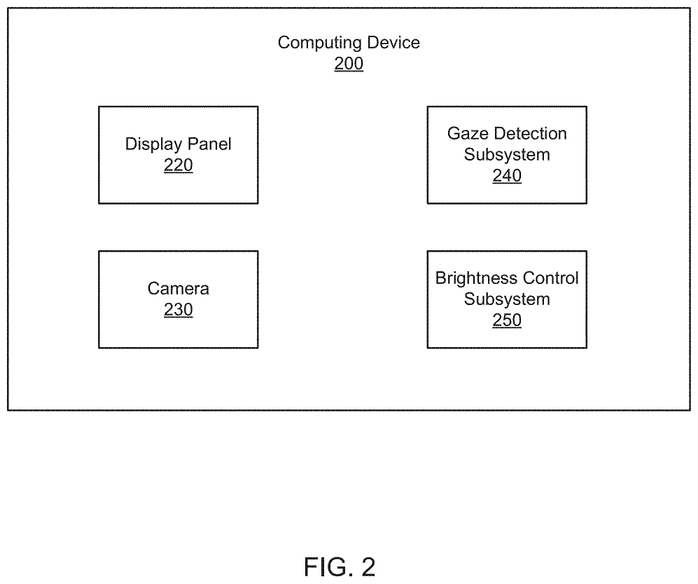

FIG. 2 illustrates a block diagram of an example of a computing device 200 to detect gaze and adjust the relative brightness of application windows based on user focus metrics. As illustrated, the computing device 200 includes a display panel 220, such as a liquid crystal display (LCD), a micro-light emitting diode (m LED) display, an organic light-emitting diode (OLED) display, or the like. In some examples, the display panel 220 comprises multiple discrete sub-display panels that together form the display panel 220.

The computing device 200 also includes a camera 230, such as an infrared camera, a near-infrared camera, a visible light optical camera, a lidar imaging system, or a combination thereof. The computing device 200 uses the camera 230 to capture images of a user during operation of the computing device 200. For example, the camera 230 may capture an image or sequence of images of the user during the operation of an application executing on the computing device 200, where the application includes an application widow displayed via the display panel 220.

The computing device 200 includes a gaze detection subsystem 240 that may, for example, be embodied as executable instructions, a field-programmable gate array, a programmable logic device, or a combination thereof. The gaze detection subsystem 240 operates to analyze the captured images to detect gaze directions of the user in the captured images. The gaze detection subsystem 240 maps the detected gaze directions to the surface of the display panel 220 to identify a discrete user focus on an application window displayed thereon. The computing device 200 includes a brightness control subsystem 250 that, again, may be embodied as executable instructions, a field-programmable gate array, a programmable logic device, or a combination thereof. The brightness control subsystem 250 operates to modify the relative brightness of an application window based on a function (e.g., a weighted function) of user focus metrics. For example, the brightness of an application window may be adjusted based on the frequency of user focus, a duration of the user focus, a recency of the user focus, or a combination thereof (including a weighted or ordered combination thereof).

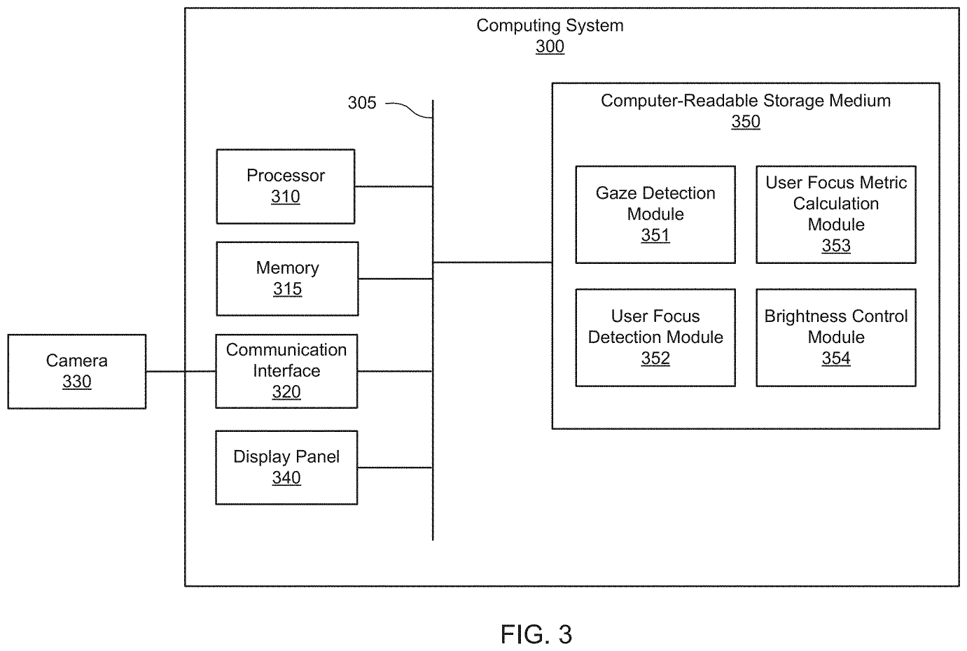

FIG. 3 illustrates an example of a computing system 300 with various modules to detect user focus and adjust the relative brightness of application windows based on user focus metrics. As illustrated, the computing system 300 includes a bus 305 that connects a processor 310, a memory, 315, a communication interface 320, a display panel 340, and a computer-readable storage medium 350. The computer-readable storage medium 350 may be, for example, a non-transitory computer-readable storage medium, as described herein. In the illustrated example, the communication interface 320 provides a data connection to an external camera 330. In other examples, a camera may be integrated as part of the computing system 300. In such examples, the communication interface 320 may still provide an internal data connection to the internal camera.

As illustrated, the computer-readable storage medium 350 includes a gaze detection module 351, a user focus detection module 352, a user focus metric calculation module 353, and a brightness control module 354. The gaze detection module 351 may, for example, include instructions that, when executed by the processor 310, cause the computing system 300 to analyze captured images to detect gaze directions of the user. The user focus detection module 352 maps detected gaze directions to the surface of the display panel 340 to identify discrete user focuses on an application window displayed on the display panel 340.

The user focus metric calculation module 353 includes instructions that, when executed by the processor, cause the computing system 300 to identify applications as either active or inactive based on a weighted function of the frequency of the user focus on each respective application, the duration of the user focus on each respective application, the recency of focus on each respective application, or a combination thereof. The brightness control module 354 includes instructions that, when executed by the processor, cause the computing system 300 to adjust the relative brightness of portions of a display panel 340 of the computing system 300. For example, the computing device may operate to dim applications identified as inactive, increase the brightness of applications identified as active, or a combination thereof.

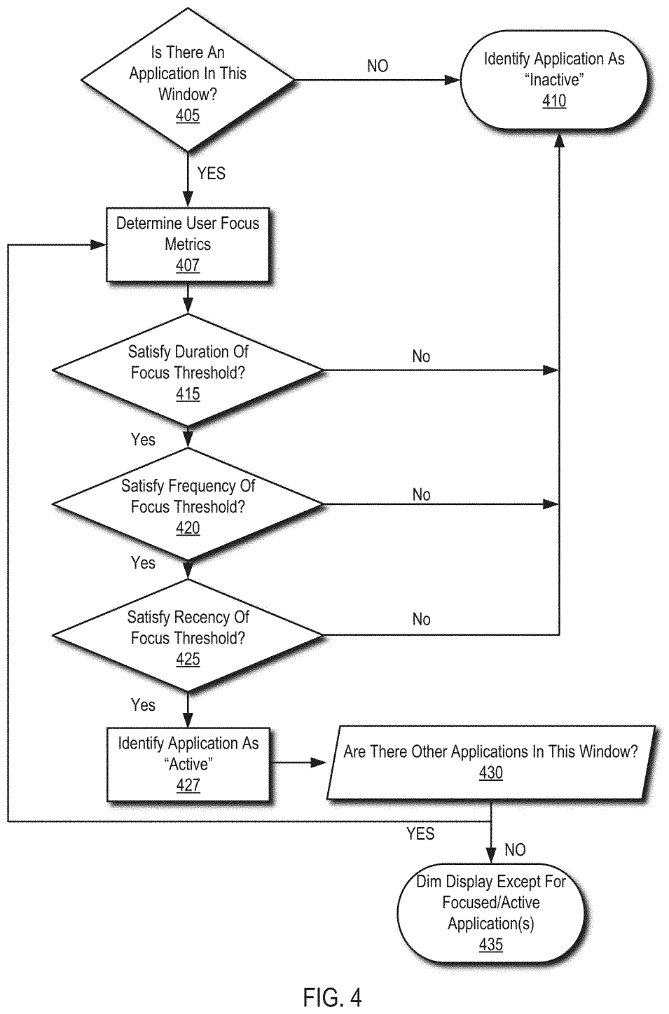

FIG. 4 illustrates a flow chart of an example method to adjust the brightness of an application window relative to another application window based on measured user focus metrics. The system determines, at 405, if an application window of a first application is displayed on a display panel of a computing device. If so, the system determines, at 407, user focus metrics of the application. For example, the system may process images of the user during operation of the application to determine a frequency of focus metric, a recency of focus metric, and a duration of focus metric.

Each application operating on the system may be associated with user focus thresholds as described herein. If a determined duration of focus metric for a given application fails to satisfy the duration of focus threshold, at 415, the application is identified as inactive, at 410. Similarly, if a determined frequency of focus metric for the application fails to satisfy the frequency of focus threshold, at 420, the application is identified as inactive, at 410. Likewise, if a determined recency of focus threshold metric for the application fails to satisfy the recency of focus threshold, at 425, the application is identified as inactive 410.

If the determined user focus metrics satisfy the established user focus thresholds, at 415, 420, and 425, then the application is identified as active 427. The method may be completed for each application in the application window, at 430. The system may implement the computation of the user focus metrics, at 407, and comparisons with the user focus thresholds, at 415, 420, and 425 for multiple applications at the same time or sequentially. The system dims portions of the display that are not associated with active applications windows, at 435. In some examples, the system dims portions of the display that are associated with inactive application windows. In some examples, the system increases the brightness of portions of the display that are associated with active application windows.

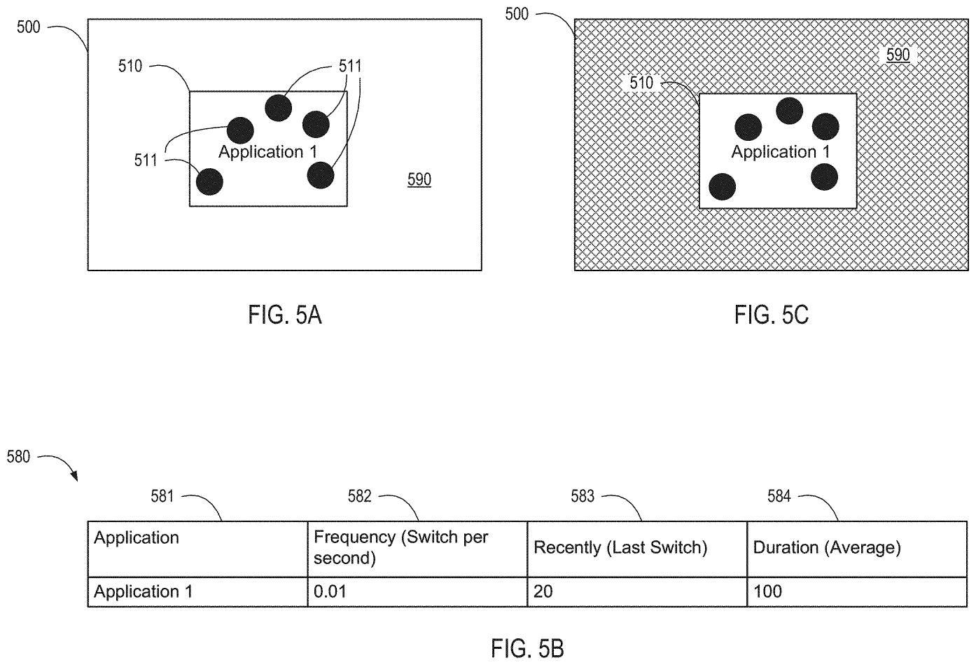

FIG. 5A illustrates an example of discrete user focuses on a first application window. A display panel 500 includes a single, first application window 510 that is displayed over a background application window 590. In the simplified illustrate example, the system identifies five user focus points 511 (shown as black dots throughout FIGS. 5A-8A) that are each on the first application window 510.

FIG. 5B illustrates an example table 580 with the user focus metrics associated with the discrete user focuses identified by the system. The illustrated user focus metrics 580 in the table 580 includes a first column 581 identifying the application to which the user focus metrics in the row correspond. The second column 582 includes computed frequency of focus user metrics. The third column 583 includes computed recency of focus user metrics and the fourth column 584 includes computed duration of focus user metrics.

The frequency of focus user metrics is expressed as a number of switches in user focus from another (different) application window to the first application window 510. The recency of user focus metrics is expressed as a time since the user last switched user focus between the first application window 510 and another (different) application window. The duration of user focus metric is expressed as an average duration of user focus on the first application window 510 (e.g., the average during a recent time period, such as the last few minutes, hour(s), or day(s)).

FIG. 5C illustrates an example of a background application window 590 dimmed in response to the computed user focus metrics columns 582, 583, and 584 in the table 580. The system identified the first application window 510 as active, the background application window 590 as inactive, or a combination thereof. Accordingly, the brightness of the first application window 510 is increased, the brightness of the background application window 590 590 is decreased, or a combination thereof.

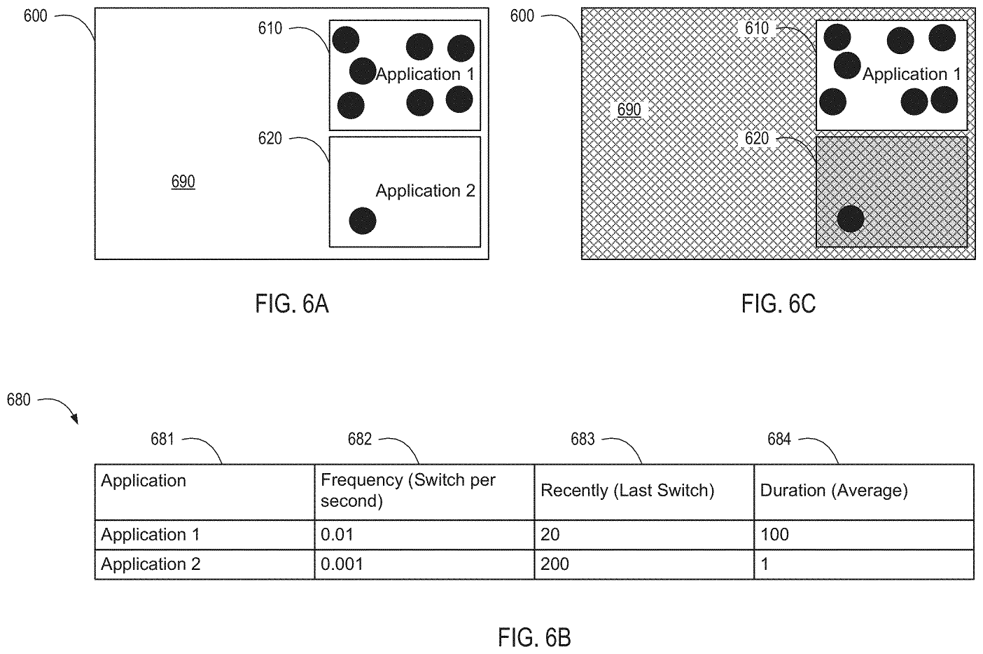

FIG. 6A illustrates another example of discrete user focuses on a first application window 610 and a second application window 620 displayed on a display panel 700. The user focuses are again illustrated as black dots but not numbered to avoid obscuring the drawing. As illustrated, seven user focuses are identified in connection with the first application window 610 and a single user focus is identified in connection with the second application window 620.

FIG. 6B illustrates an example table 680 with the user focus metrics associated with the discrete user focuses on each of the first application and the second application listed in the application column 681. Again, the first column 681 identifies the application to which the user focus metrics in the row correspond. The second column 682 includes computed frequency of focus user metrics. The third column 683 includes computed recency of focus user metrics and the fourth column 684 includes computed duration of focus user metrics.

Based on the example user focus metrics in table 680, the user looks at (e.g., focuses on) the first application window 610 once every 100 seconds for an average of 100 seconds each time. The user focuses on the second application window 620 every 1000 seconds for an average of 1 second each time. It has been 200 seconds since the user last focused on the second application window 620. In the illustrated example, the system has identified the first application window 610 as active and the second application window 620 as inactive. The background application window 690 is also identified as inactive.

FIG. 6C illustrates an example display panel 600 with adjustments to the relative brightness of the first application window 610, the second application window 620, and the background application window 690 based on the user focus metrics expressed in FIG. 6C. Specifically, the system has increased the brightness of the first application window 610, decreased the brightness of the second application window 620, decreased the brightness of the background application window 690, or a combination thereof.

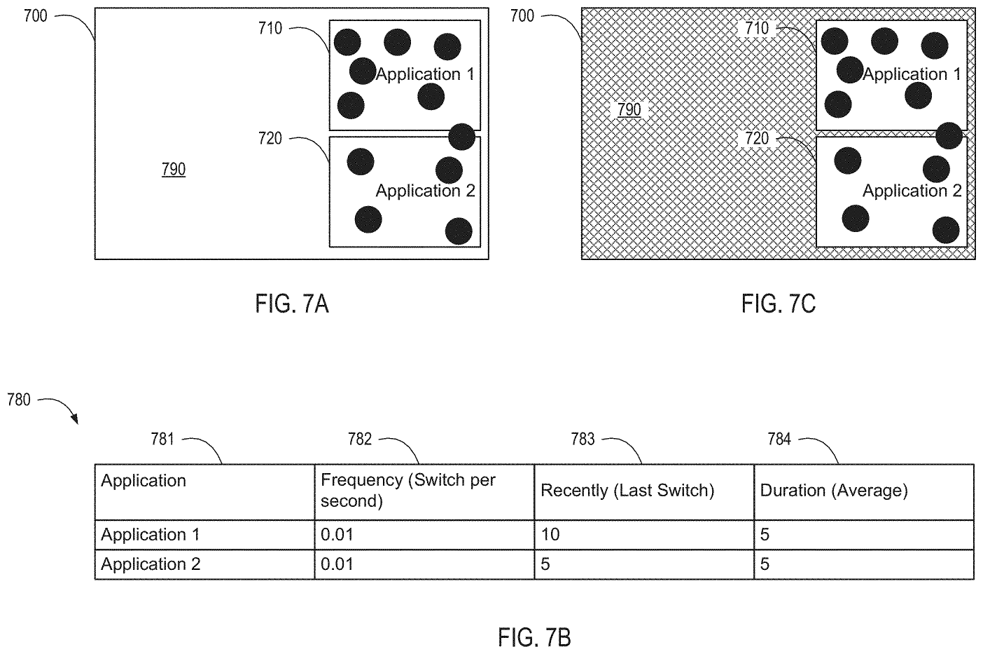

FIG. 7A illustrates another example of discrete user focuses on a first application window 710 and a second application window 720 displayed on a display panel 700. The user focuses are again illustrated as black dots but not numbered to avoid obscuring the drawing. As illustrated, six user focuses are identified in connection with the first application window 710, four user focuses are identified in connection with the second application window 720, and one user focus is identified in connection with the background application window 790.

FIG. 7B illustrates an example table 780 with the user focus metrics associated with the discrete user focuses. Again, the first column 781 identifies the application to which the user focus metrics in the row correspond. The second column 782 includes computed frequency of focus user metrics. The third column 783 includes computed recency of focus user metrics and the fourth column 784 includes computed duration of focus user metrics.

Based on the example user focus metrics in table 780, the user looks at (e.g., focuses on) the first application window 710 once every 100 seconds for an average of five seconds each time. The user last looked at the first application window 710 10 seconds ago. The user focuses on the second application window 720 every 100 seconds for an average of 5 seconds each time. It has been 5 seconds since the user last focused on the second application window 720. In the illustrated example, the system has identified the first application window 710 as active, the second application window 720 as active, and the background application window 790 as inactive.

FIG. 7C illustrates an example display panel 700 with the background application window 790 dimmed relative to the active first and second application windows 710 and 720, based on the user focus metrics in table 780. Specifically, the system has increased the brightness of the first application window 710, increased the brightness of the second application window 720, decreased the brightness of the background application window 790, or a combination thereof.

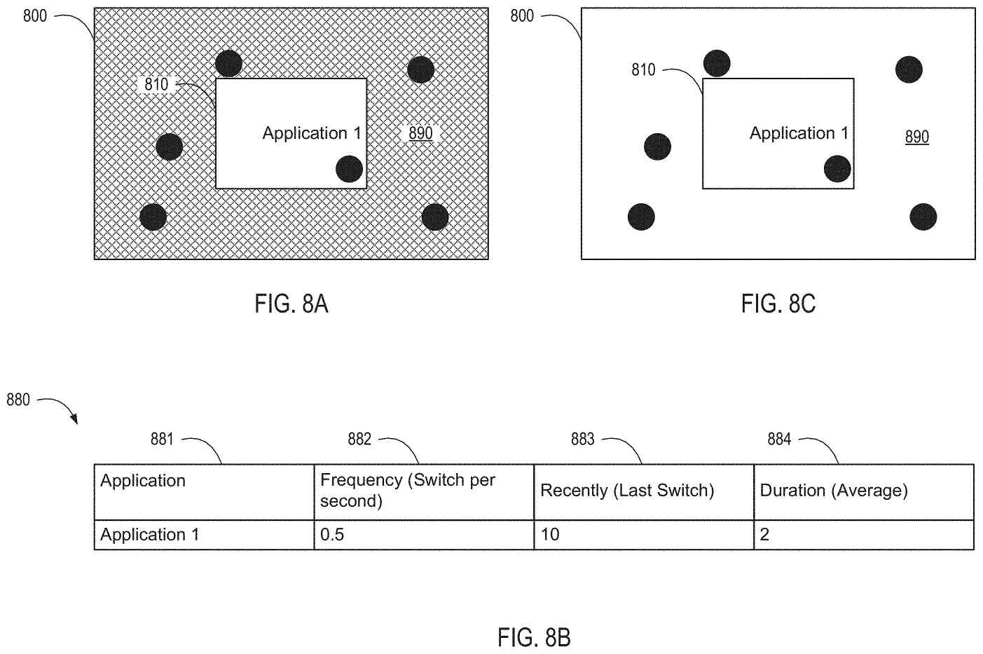

FIG. 8A illustrates an example of discrete user focuses on a background application window 890 and a first application window 810 on a display panel 800. Again, the user focuses are illustrated as black dots but not numbered to avoid obscuring the drawing. In the illustrated example, the background application window 890 was previously identified as inactive, the first application window 810 was identified as active, or both. Based on the earlier analysis, the system had dimmed the background application window 890. In the illustrated example, the user focus is now primarily on the background application window 890, which was previously identified as inactive. Specifically, five user focuses are identified in connection with the background application window 890 and only a single user focus is identified in connection with the first application window 710.

FIG. 8B illustrates an example table 880 with the user focus metrics associated with the discrete user focuses. Again, the first column 881 identifies the application to which the user focus metrics in the row correspond. The second column 882 includes computed frequency of focus user metrics. The third column 883 includes computed recency of focus user metrics and the fourth column 884 includes computed duration of focus user metrics. Notably, there is no row for the background application window 890. In the illustrated example, rather than identify user focus metrics for the background application window 890, the system adjusts the relative brightness of the background application window 890 based on the active or inactive status of other application windows displayed on the display panel 800.

For instance, the background application window 890 may be dimmed when any number of other application windows are identified as active. Similarly, the system may increase the brightness of the background application window 890 when all other displayed application windows are identified as inactive. In alternative examples, the background application window may be treated similarly to the other application windows and have its brightness increased and decreased based on computed user focus metrics.

Based on the example user focus metrics in table 880, the user looks at (e.g., focuses on) the first application window 810 once every 2 seconds for an average of 2 seconds each time. The user last looked at the first application window 810 10 seconds ago. Based on the relatively high frequency of user focus, the relatively low recency of focus, the relatively low duration of focus, or a combination thereof, the system determines that the first application window 810 is inactive. Since there are no other application windows displayed on the display panel 800, the system increases the brightness of the background application window 890.

FIG. 8C illustrates an example display panel 800 with the brightness of the background application window 890 increased relative to the first application window 810, based on the user focus metrics.

Specific examples of the disclosure are described above and illustrated in the figures. It is, however, appreciated that many adaptations and modifications can be made to the specific configurations and components detailed above. In some cases, well-known features, structures, and/or operations are not shown or described in detail. Furthermore, the described features, structures, or operations may be combined in any suitable manner. Thus, all feasible permutations and combinations of examples are contemplated.

In the description above, various features are sometimes grouped together in a single example, figure, or description thereof for the purpose of streamlining the disclosure. This method of disclosure, however, is not to be interpreted as reflecting an intention that any claim now presented or presented in the future requires more features than those expressly recited in that claim. Rather, it is appreciated that inventive aspects lie in a combination of fewer than all features of any single foregoing disclosed example. The claims are hereby expressly incorporated into this Detailed Description, with each claim standing on its own as a separate example. This disclosure includes all permutations and combinations of the independent claims with their dependent claims.

1. A computing device, comprising:
a display panel;
a camera to capture images of a user during operation of the computing device with a first application executing thereon, the first application including a first application window displayed via the display panel;
a gaze detection circuit to:
identify a portion of the display panel that displays the first application window,
detect gaze directions of the user in the captured images, and
identify discrete user focuses that correspond to the portion of the display panel that displays the first application window based on the detected gaze directions; and
a brightness control circuit to modify a relative brightness of the first application window based on a function of the frequency of user focus, duration of user focus, and recency of user focus on the first application window, wherein the brightness control circuit is further to modify the relative brightness of the first application window by:
(i) decreasing or increasing the brightness of the first application window,
(ii) decreasing or increasing a brightness of a second application window of a second application executing on the computing device,
(iii) increasing or decreasing a brightness of a background displayed on the display panel, or
(iv) a combination thereof.

2. The computing device of claim 1, further comprising an application assignment circuit to:
monitor user focus during user-operation of the first application during a calibration time period;
determine a frequency of focus threshold for the first application;
determine a duration of focus threshold for the first application; and
determine a recency of focus threshold for the first application.

3. The computing device of claim 2, wherein the frequency of focus threshold is expressed in terms of an average number of user focus switches between the first application and the second application per time unit.

4. The computing device of claim 2, wherein the duration of focus threshold is expressed in terms of an average amount of time the user maintains the user focus on the first application.

5. The computing device of claim 2, wherein the recency of focus threshold is expressed as an average amount of time that elapses before switching the user focus from the second application executing on the computing device to the first application.

6. (canceled)

7. The computing device of claim 2, wherein the brightness control circuit is to increase the brightness of the first application window displayed on the display panel based on:
(i) the frequency of user focus on the first application window being above the determined frequency of focus threshold for the first application,
(ii) the duration of user focus on the first application window being above the determined duration of focus threshold for the first application,
(iii) the recency of focus on the first application window being above the determined recency of focus threshold for the first application, or
(iv) a combination thereof.

8. A non-transitory computer-readable medium with instructions stored thereon that, when executed by a processor of a computing device, cause the computing device to:
detect gaze directions of a user in images of the user captured during operation of the computing device;
compute discrete user focuses on application windows corresponding to a first application and to a second application operating on the computing device using the captured images and the detected gaze directions;
identify each of the first application and second application as either (i) active or (ii) inactive based on a weighted function of:
the frequency of the user focus on each respective application,
the duration of the user focus on each respective application, and
the recency of focus on each respective application; and
adjust the relative brightness of portions of a display panel of the computing device such that each application identified as active is brighter than each application identified as inactive, wherein the relative brightness of each application identified as active is adjusted by:
(i) decreasing or increasing the brightness of the first application window,
(ii) decreasing or increasing the brightness of the second application window,
(iii) increasing or decreasing a brightness of a background displayed on the display panel, or
(iv) a combination thereof.

9. The non-transitory computer-readable medium of claim 8, wherein the instructions, when executed by the processor, further cause the computing device to monitor user focus during user-operation of each of the first and second applications during a calibration time period to:
determine a frequency of focus threshold for each of the first and second applications of the computing device;
determine a duration of focus threshold for each of the first and second applications of the computing device; and
determine a recency of focus threshold for each of the first and second applications operating on the computing device.

10. The non-transitory computer-readable medium of claim 9, wherein the frequency of focus threshold is expressed in terms of an average number of user focus switches to each respective application per time unit,
wherein the duration of focus threshold is expressed in terms of an average amount of time the user maintains user focus on each respective application before switching user focus, and
wherein the recency of focus threshold is expressed as an average amount of time that elapses before switching the user focus to each respective application.

11. The non-transitory computer-readable medium of claim 9, wherein the instructions, when executed by the processor, cause the computing device to adjust the relative brightness by increasing the brightness of a portion of the display panel that includes the application window of each application identified as active.

12. The non-transitory computer-readable medium of claim 9, wherein the instructions, when executed by the processor, cause the computing device to adjust the relative brightness by dimming a portion of the display panel that includes the application window of each application identified as inactive.

13. A non-transitory computer-readable medium with instructions stored thereon that, when executed by a processor of a computing device, cause the computing device to:
detect gaze directions of a user in images of the user captured during operation of a first application executing on the computing device;
identify a portion of a display panel that displays a first application window of the first application;
compute, for each captured image, a discrete user focus that corresponds to the portion of the display panel that displays the first application window of the first application based on the detected gaze directions; and
adjust the relative brightness of the first application based on user focus metrics, wherein the relative brightness of the first application is adjusted by:
(i) decreasing or increasing the brightness of the first application window,
(ii) decreasing or increasing a brightness of a second application window of a second application executing on the computing device,
(iii) increasing or decreasing a brightness of a background displayed on the display panel, or
(iv) a combination thereof.

14. The non-transitory computer-readable medium of claim 13, wherein the user focus metrics comprise:
(i) a frequency of user focus on the first application window,
(ii) a duration of user focus on the first application window,
(iii) a recency of focus on the first application window, or
(iv) a combination thereof.

15. The non-transitory computer-readable medium of claim 14, wherein the frequency of user focus is expressed in terms of an average number of user focus switches per time unit,
wherein the duration of user focus is expressed in terms of an average amount of time the user maintains user focus before switching user focus to the second application, and
wherein the recency of focus is expressed as an average amount of time that elapses before switching the user focus to the first application from the second application.
